(19) United States
(12) Patent Application Publication
(10) Pub. No.: US 2017/0118318 A1
(43) Pub. Date: Apr. 27, 2017

(54) Mobile Phone

(71) Applicants: Le Holdings (Beijing) Co., Ltd., Beijing (CN); LeCloud Computing Co., Ltd., Beijing (CN)

(72) Inventor: Lan Ma, Beijing (CN)

(21) Appl. No.: 15/252,474

(22) Filed: Aug. 31, 2016

Related U.S. Application Data
(63) Continuation of application No. PCT/CN2016/083158, filed on May 24, 2016.

(30) Foreign Application Priority Data
Oct. 21, 2015 (CN) 201520818061.9

(51) Int. Cl. H04M 1/02; H04W 4/02

(52) U.S. Cl. CPC H04M 1/027; H04M 1/0235; H04W 4/023

(57) ABSTRACT

A mobile phone including a first touch screen and a second touch screen respectively coupled to a processor; a transmitter and a receiver respectively coupled to the processor; a memorizer coupled to the processor, which stores speech recognition database and contacts database; a mobile communication unit and a video communication unit both coupled to the processor, the mobile communication unit associated with the first touch screen, including a customer recognition module, a baseband processing chip and an RF module; the video communication unit associated with the second touch screen, including a front camera, an image processing chip and a wireless communication module. Mobile phone of the disclosure provides two touch screens dedicated for call, which makes the elderly very convenient due to the very few interaction level of the mobile phone.

### CROSS REFERENCE TO RELATED APPLICATIONS

This application is a continuation of International Application No. PCT/CN2016/083158, filed on May 24, 2016, which is based upon and claims priority to Chinese Patent Application No. 201520818061.9, filed on Oct. 21, 2015, the entire contents of which are incorporated herein by reference.

### TECHNICAL FIELD

The disclosure relates to the field of mobile communications equipment, and particularly to a mobile phone.

### BACKGROUND

With the increase of people's communication needs, mobile phone has become a popular communication tool. Currently, mobile phone is generally divided into two categories: one is functional machine, which is the traditional non-smart phones with screen and multiple keys, and the other is large-screen smart phone. But they are generally suitable for young people to use, and not convenient for the elderly to use.

Taking the first category of functional machine for example, although these mobile phones have features of longer standby time and relatively simple functions, but for the old people with lapsed vision and memory, it is very difficult to get start to use them due to its small screen and operations depending too heavily on entity keys. For the functions of voice call and video call which are commonly used by the elderly, it is necessary to remember the functions of specific entity keys (function keys of non-intuitive visualization) and operational processes, resulting that the elderly cannot exactly find out contacts to contact because of the complicated operational processes and small screen, which makes it very inconvenient for the elderly to communicate with others through mobile phone.

Although the second category of large-screen smart phone solves the problem of vision deficiency for the elderly to some extent, it has also obvious defects. As for the smart phone, it has rich functions and complicated operation interface. Touch screen is the main entrance of interaction through which each function page needs to be separately operated and displayed. Touch screen is only equivalent of a peripheral device coupled to the processor, but is not involved in direct contact with core function module. It has disadvantages in that repeated operation of the touch screen are needed to enter the corresponding function page and hierarchical menu to switch the corresponding function during the elderly makes a most common voice call or video call. This problem becomes more obvious when switching from a voice call to a video call. The elderly needs to repeatedly operate the touch screen to enter the voice interface for voice calls, and to operate the touch screen to see the video call menu after the completion of voice call and then repeatedly operate the touch screen to enter the video interface for video calls. The tedious operation levels and display of different menus have become a huge challenge to the vision and memory of the elderly, which similarly renders inconvenience in use.

### SUMMARY

The present application provides a mobile phone, which solves the problem of inconvenient operation of the elderly in the prior art because of poor eyesight and memory.

A mobile phone provided by the embodiment of the present application includes: a first touch screen and a second touch screen; a processor coupled to the first touch screen and the second touch screen; a transmitter and a receiver respectively coupled to the processor; a memorizer coupled to the processor and storing speech recognition database and contacts database; a mobile communication unit and a video communication unit both coupled to the processor, the mobile communication unit associated with the first touch screen and including a customer recognition module, a baseband processing chip and an RF module; the video communication unit associated with the second touch screen and including a front camera, an image processing chip and a wireless communication module.

In the present application, since a first touch screen is associated with a mobile communication unit and a second touch screen is associated with a video communication unit, the two touch screens both involve in direct contact with core function module. When used in combination with a processor and a memorizer, a transmitter can be activated when a user wants to make a voice or a video call through touching a corresponding touch screen. At this time, upon the user's speaking of the contacts name, the transmitter gathers the user's voice signal and makes a sound/electronic conversion. When the processor receives the voice signal transmitted by the transmitter, the processor first stores the voice signal in speech recognition database and then recognizes it and match the identified contact's name in the contacts database to find the contacts information. After the contacts information is found out, the processor controls the mobile communication unit to dial the phone number of target contacts or controls the video communication unit to conduct a video call with the target contacts. Accordingly, direct call by one key is achieved through touching-speaking contacts name-calling without need to repeatedly touch the screen. Moreover, when the user wants to make a switch between a voice call and a video call, he/she only needs to click on the first or second touch screen corresponding to voice call or video call without need to exit and enter the corresponding function page and hierarchical menu, thus reducing the operating level, making the operation process clear at a glance, and facilitating the use of the elderly.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a mobile phone according to an embodiment of the present application;

FIG. 2 is a front view of the mobile phone shown in FIG. 1;

FIG. 3a and FIG. 3b are side views of a mobile phone according to an embodiment of the present application;

FIG. 4 is a back view of a mobile phone according to an embodiment of the present application;

FIG. 5 is a schematic diagram showing a motion monitoring device in a mobile phone according to another embodiment of the present application; and

FIG. 6 is a schematic diagram showing a positioning unit in a mobile phone according to yet another embodiment of the present application.

### DETAILED DESCRIPTION

The purposes and objects as well as the characteristics and advantages of the application shall be better appreciated from the detailed description of embodiments with reference to the accompanying drawings. Apparently, these embodiments are only part of embodiments of the present application. Those of ordinary skilled in the art will appreciate that other embodiments can also be made based on these embodiments without inventive efforts, all of which are within the protection scope of the present application.

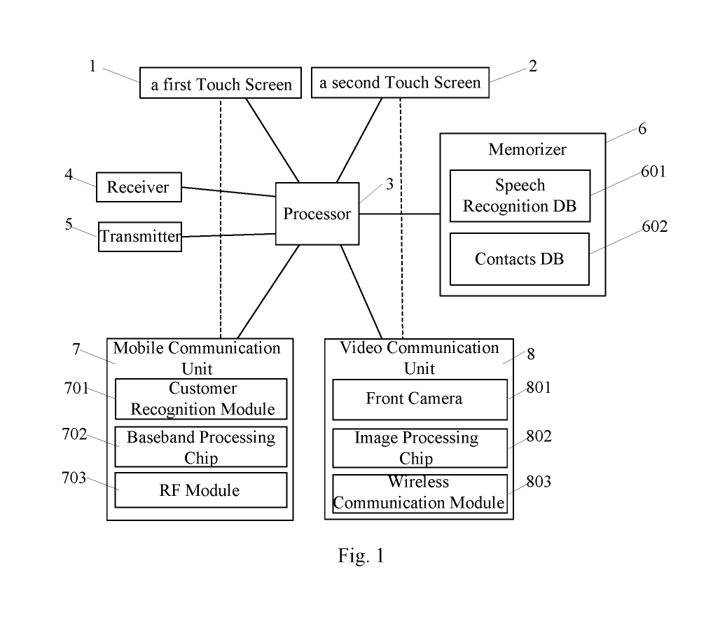

FIG. 1 is a schematic diagram of a mobile phone according to an embodiment of the present application.

As shown in FIG. 1, the mobile phone includes: a first touch screen 1, a second touch screen 2, a processor 3, a receiver 4, a transmitter 5, a memorizer 6, a mobile communication unit 7 and a video communication unit 8. The first touch screen 1, the second touch screen 2, the transmitter 5, the receiver 4, the memorizer 6 and the mobile communication unit 7 are coupled to the processor 3, respectively. The first touch screen 1 is associated with the mobile communication unit 7, and the second touch screen 2 is associated with the video communication unit 8.

The term “associate”, as used herein, means “directly connect”, “indirectly connect” or “link.” Those skilled in the art can configure the way thereof as needed according to the actual situation.

The transmitter 5 is used to collect voice input of user to convert the voice input into analog signals and send the analog signals to the processor 3 for further processing.

The receiver 4 is used to convert the audio signals into sound signals and play the sound signals. The receiver may be a handset or a speaker. In this embodiment, the receiver 4 is a high frequency loudspeaker.

The memorizer 6 stores voice recognition database and contacts database, which are used to assist the processor 3 to perform the processes of speech recognition and contacts match for the analog signals collected and converted by the transmitter 5.

The mobile communication unit 7 includes a customer recognition module (Here is a SIM card socket) 701, a baseband processing chip 702 and an RF module 703. In which the SIM card socket 701 is used to place phone's SIM card, the RF module 703 is used to receive and send signals and the baseband processing chip 702 is used to implement the communication of voice information between the mobile phone and other terminal devices.

The video communication unit 8 includes a front camera 801, an image processing chip 802 and a wireless communication module 803. In which the front camera 801 is used to gather the video information of user and send the gathered video information to the image processing chip 802. The image processing chip 802 is used to process the gathered video information. The wireless communication module is a communication module based on at least one of WIFI, 3G and 4G, which is used to implement the interaction of video and voice information between this mobile phone and other terminal devices for video call such as cell phone and computers, etc.

When a user wants to make a voice call with others, he/she can touch the first touch screen 1 to activate the transmitter 5, and speaks the contact name. At this point the transmitter 5 gathers the user's video information and makes sound/electronic conversion. After the processor 3 receives the voice signal transmitted by the transmitter 5, it will carry out speech recognition in the speech recognition database 601 and match the identified contact's name in the contacts database 602. After the contacts information is found, the processor 3 controls the mobile communication unit 7 to automatically dial the phone number of the contacts. The contacts information and dialing status can be displayed on the first touch screen 1 associated with the mobile communication unit 7. Then the transmitter 5 and the receiver 4 of the phone perform input and output of the user's voice information.

When a user wants to make a video call with others, he/she can touch the second touch screen 2 to activate the transmitter 5, and speaks the contact name. At this point the transmitter 5 gathers the user's voice information and makes sound/electronic conversion. After the processor 3 receives the voice signal transmitted by the transmitter 5, it will carry out speech recognition in the speech recognition database 601 and match the identified contact's name in the contacts database 602. After the contacts information is found, the processor 3 controls the video communication unit 8 to start the built-in video software to make a video call with the target contacts. After the video call is started, the front camera 801 gathers the user's video information and sends it to the image processing chip 802 to process. Interchange of the processed video information and the video information sent by the contacts is conducted by the wireless communication module 803 and these information are displayed on the second touch screen 2 associated with the video communication unit 8. At the same time, the phone performs input and output the voice information of user by the receiver 4 and the transmitter 5.

In this embodiment, since the first touch screen 1 is associated with the mobile communication unit 7 and the second touch screen 2 is associated with a video communication unit 8, the two touch screens both involve in direct contact with core function module. When a user selects to make a voice call or a video call, he/she can simply touch a corresponding touch screen and speak the contact name to the phone. Thus the call can be completed by one-touch access without need for repeated operation to touch screen. Moreover, when the user wants to make a switch for voice call and video call, he/she only needs to click on the first or second touch screen corresponding to voice call or video call without need to exit and enter the corresponding function page and hierarchical menu by operating the touch screen, thus reducing the operating level and making the operation process clear at a glance for user.

Mobile phone of the present application provides two touch screens dedicated for call, the interaction of different touch screens can achieve, by cooperation with processor and memorizer, voice search of contacts and completion of corresponding voice call or video call, which makes it very convenient for the elderly to use due to the very few interaction level of the mobile phone.

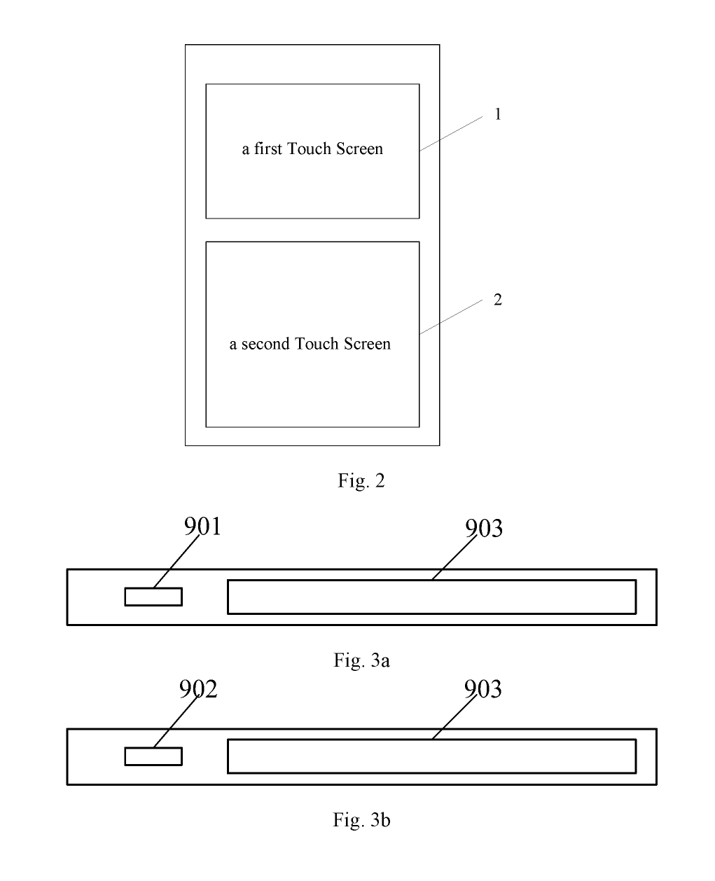

With reference to FIG. 2 further, the front of the phone includes the first touch screen 1 and the second touch screen 2, in which the size of the second touch screen is greater than the size of the first touch screen so as to facilitate the user who often uses video call, particularly the elderly, to have a more clear view of video images.

In addition, the first touch screen is a black-and-white screen and the second touch screen is a color screen. The first touch screen adopting black-and-white screen can not only distinguish the first touch screen 1 from the second touch screen 2, but also save power and increase the phone's battery life. Alternatively, the first touch screen can be a low-resolution color screen, and the second touch screen can be a high-resolution color screen The first and second touch screens can be physical or a virtual interface. The first touch screen 1 and the second touch screen 2 can also be configured according to user's need, which is not limited to this embodiment, For example, the second touch screen may be located above the first touch screen and the second touch screen may be smaller than the first touch screen and so on.

FIG. 3a and FIG. 3b are side views of a mobile phone according to an embodiment of the present application. As shown in FIG. 3a and FIG. 3b, in this embodiment, a first key 901, a second key 902 and an LED lamp band 903 associated with the mobile communication unit and/or the video communication unit, are arranged on the borders of the mobile phone. The first key 901 is a power key used to control lock screen/light screen and turn on/off the mobile phone, the second key is a camera key. The power key can be designed to operate lock screen/light screen by short press and to operate turn on/off the mobile phone by long press. FIG. 3a is a schematic diagram of one side of the mobile phone in this embodiment at which the power key 901 is located. FIG. 3b is a schematic diagram of the other side of the mobile phone in this embodiment, the camera key 902 is located on this side. The power key 901 and the camera key 902 are located at both sides of the phone, which reduces number of keys to be remembered by users and avoids the possible confusion. For the elderly, there are only two keys in the mobile phone, which make it possible to reduce the number of key to be remembered for the elderly, so that not only the tendency to causing confusion can be avoided, but also the inconvenience during talking on mobile phone due to the reduced volume caused by operation mistake can be avoided, especially for the elderly with poor hearing. The LED lamp band 903 can twinkle in yellow light with high-frequency when the mobile phone calls. The use of LED lamp band can address the issue that the elderly cannot timely receive the incoming call prompt caused by the poor hearing. When it is used with power of phone together, the LED lamp band 903 can twinkle in red light with high-frequency in the case that the power of mobile phone drops below 10%. Therefore, it can help to remind the elderly to charge the mobile phone to prevent the mobile phone from automatically shutting down due to power consumption. Keys and LED lamp band are also not limited by descriptions in this embodiment and the accompanying drawings. For example, keys may be located at any side of a phone, or the power key and camera key located at both sides of the phone may be symmetrical or asymmetric, and the LED lamp band may be continuous or spaced as long as the LED lamp band can cover the sides of phone, and so on.

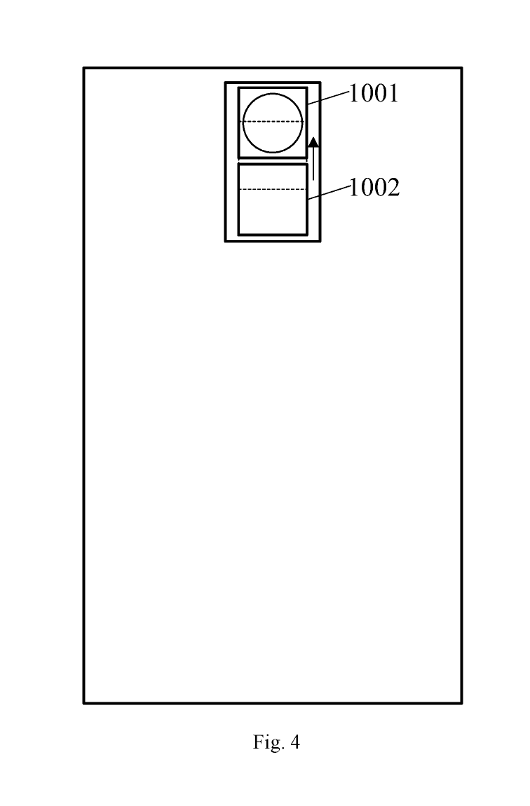

With reference to FIG. 4, the mobile phone of this embodiment includes a rear camera 1001 coupled to the image processing chip 802 and a magnifying glass 1002 slidably mounted on the mobile phone back shell. As shown in FIG. 4, the magnifying glass 1002 is arranged in the groove having the rear camera 1001, and it can slide up and down. When the magnifying glass 1002 is to be used, the magnifying glass 1002 can slide up in the direction of arrow as illustrated to block the rear camera 1001. When the magnifying glass 1002 is not intended to be used, the magnifying glass 1002 can slide down in the opposite direction of arrow as illustrated to the position not to block the rear camera. Since the elderly are generally poor eyesight, they may open the rear camera and slide the magnifying glass to the first sliding position to block the rear camera when it is necessary to look at small objects or read newspapers and books. At this time, an enlarged image of the object is showed on the second touch screen. When the elderly do not need to use a magnifying glass, the magnifying glass can be slide to the second sliding position to not block the rear camera. By the combined use of the rear camera and a magnifying glass, the elderly with poor vision can read text more clearly and easily or look at small objects and take a picture. The rear camera 1001 and the magnifying glass 1002 are also not limited by descriptions in this embodiment and FIG. 4. Those of ordinary skilled in the art can make a variation or equivalent design based on the above illustration. For example, the rear camera 1001 may be arranged under the magnifying glass 1002 or the magnifying glass 1002 may be arranged to slide left and right and so on.

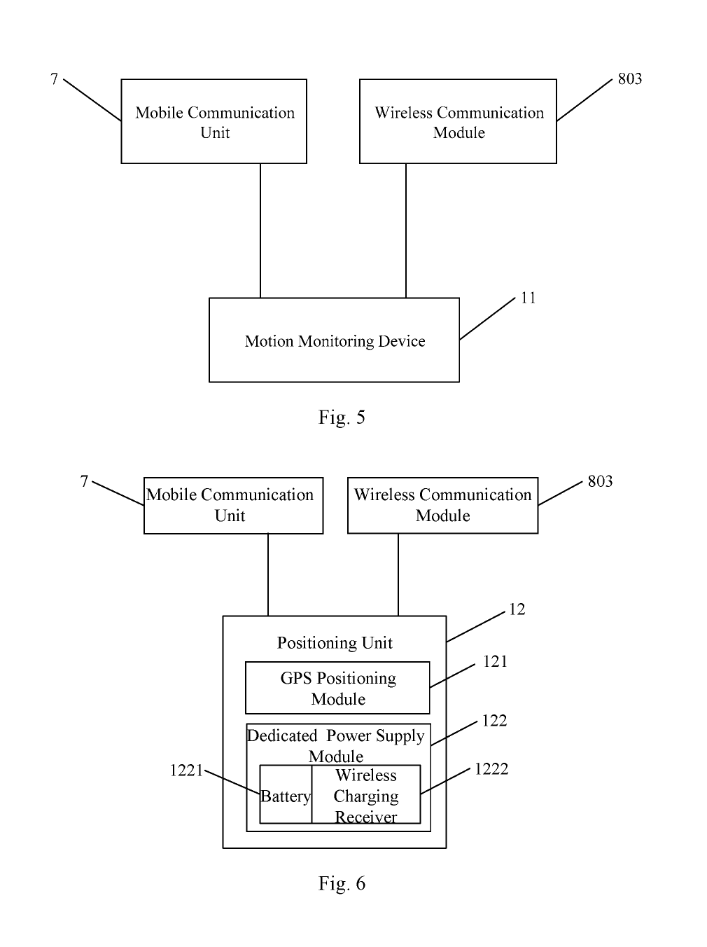

FIG. 5 is a schematic diagram showing a motion monitoring device in a mobile phone according to another embodiment of the present application. As shown in FIG. 5, the mobile phone in this embodiment includes a motion monitoring device 11 associated with the mobile communication unit 7 and/or the wireless communication module 803. The motion monitoring device 11 can be associated with the mobile communication unit 7 or with the wireless communication module 803 selectively. In this embodiment, the motion monitoring device 11 may be a nine-axis or six-axis measurement sensor. When a user falls or drops, the motion monitoring device 11 with nine-axis or six-axis can sense the acceleration and angular velocity of the phone and obtain the gesture of the phone according to the sensing signal so as to determine whether the user falls. When the motion monitoring device is used in conjunction with appropriate software, it can be configured to take advantage of a mobile communication unit and/or a wireless communication module automatically to dial the contacts with the highest frequency of call in mobile phone for voice call or video call, in case a tumble accident is determined.

FIG. 6 is a schematic diagram showing a positioning unit in a mobile phone according to yet another embodiment of the present application. As shown in FIG. 6, the mobile phone in this embodiment includes a positioning unit 12 associated with the mobile communication unit 7 and/or the wireless communication module 803. The positioning unit 12 includes a GPS positioning module 121 and a dedicated power supply module 122 coupled with the GPS positioning module 121, in which the power supply module 122 is independent from the power supply for the phone. As the positioning unit 12 is associated with the mobile communication unit 7 and/or the wireless communication module 803, when the phone remains power state, the positioning unit 12 can upload the user's location information to the corresponding receiving end at any time. Even when the phone is turned off, it can also upload the location information to the receiving end via its own GPS positioning module 121 by using the dedicated power supply module 122 to power the phone, because the positioning unit can be powered by a separate dedicated power supply module. So user's family members can identify the location of the elderly in cooperation with a corresponding receiving means. In this embodiment, the dedicated power supply module 122 includes a battery 1221 and a wireless charging receiver 1222. The battery 1221 disposed inside the phone does not expose, the wireless charging receiver 1222 can use any one of the standards such as PMA standard, Qi standard and A4WP standard. As battery in the GPS positioning module is designed to be wireless chargeable, frequent disassembly and assembly of battery can be avoided. So the battery in the GPS positioning module can be built-in and not exposed in order to reduce the trouble and burden of memory of the elderly when they use a mobile phone having its own battery and a GPS battery.

It should be noted that above-mentioned embodiments are merely illustrative, in which the unit described as a separate member may or may not be physically separated. The purpose of the present application can be achieved by using part or all of the modules based on actual demand. Those of ordinary skilled in the art can understand and implement above-mentioned embodiments without paying any creative work.

Through descriptions on above embodiments, those skilled in the art can clearly understand that various embodiments may be implemented by software plus a necessary universal hardware platform. Of course, they may also be implemented by hardware. Based on this understanding, above technical solutions in essence or the part contributing to the prior art can be embodied in the form of software products, the software product may be stored in a computer readable storage medium, such as ROM/RAM, etc.

Finally, it should be noted that above embodiments are merely provided for describing the technical solutions of the present application, but not intended to limit it. Although the present application has been described in detail with reference to the above-mentioned embodiments, those skilled in the art will appreciate that the technical solutions described in the foregoing various embodiments can be modified or make equivalent replacements to some technical features. And such modifications or replacements do not make the essence of corresponding technical solutions depart from the spirit and scope of the various embodiments of the present application.

What is claimed is:

1. A mobile phone comprising:
a first touch screen and a second touch screen;
a processor coupled with the first touch screen and the second touch screen;
a transmitter and a receiver respectively coupled to the processor;
a memorizer coupled to the processor, the memorizer stores speech recognition database and contacts database;
a mobile communication unit and a video communication unit both coupled to the processor, the mobile communication unit being associated with the first touch screen, and including a client recognition module, a baseband processing chip and an RF module; the video communication unit being associated with the second touch screen and including a front camera, an image processing chip and a wireless communication module.

2. The mobile phone according to claim 1, wherein the size of the second touch screen is greater than the size of the first touch screen.

3. The mobile phone according to claim 1, wherein the first touch screen is a black-and-white screen and the second touch screen is a color screen.

4. The mobile phone according to claim 1, wherein the mobile phone further comprises a rear camera coupled to the image processing chip and a magnifying glass slidably mounted on the mobile phone back shell, the magnifying glass having a first sliding position for blocking the rear camera and a second sliding position for exposing the rear camera.

5. The mobile phone according to claim 1, wherein the mobile phone further comprises a motion monitoring device associated with the mobile communication unit and/or the wireless communication module.

6. The mobile phone according to claim 5, wherein the motion monitoring device is a nine-axis or six-axis measurement sensor.

7. The mobile phone according to claim 1, wherein the mobile phone further comprises a LED lamp band arranged on the borders of the mobile phone and associated with the mobile communication unit and/or the video communication unit.

8. The mobile phone according to claim 1, wherein the mobile phone further comprises a first key and a second key, the first key being a power key used to control lock screen/light screen and turn on/off the mobile phone, the second key being a camera key.

9. The mobile phone according to claim 1, wherein the mobile phone further comprises a positioning unit associated with mobile communication unit and/or the wireless communication module, and the positioning unit comprises a GPS positioning module and a dedicated power supply module coupled to the GPS positioning module and being independent of the mobile phone.

10. The mobile phone according to claim 9, wherein the dedicated power supply module comprises a battery and a wireless charging receiver.
